(19) United States
(12) Patent Application Publication
(10) Pub. No.: US 2015/0194243 A1
(43) Pub. Date: Jul. 9, 2015

(54) METHOD FOR PRODUCING A STRUCTURAL COMPONENT

(71) Applicant: VOESTALPINE KREMS GMBH, Krems an der Donau (AT)

(72) Inventors: Hans Pflügl, Rohrendorf (AT); Alfred Seyr, Statzendorf (AT); Christian Hauser, Wien (AT)

(21) Appl. No.: 14/411,606

(22) PCT Filed: Jul. 1, 2013
(86) PCT No.: PCT/EP2013/062875

§ 371 Date: Dec. 29, 2014

(30) Foreign Application Priority Data
Jun. 29, 2012 (EP) 12174391.8

(51) Int. Cl. H01B 13/26; H02G 3/04

(52) U.S. Cl. CPC H01B 13/266; H02G 3/04

(57) ABSTRACT

The invention discloses a method for producing a structural component, in particular for a vehicle, in which a piece of sheet metal is shaped into an open or closed, in particular multi-chambered, hollow profile and is provided with at least one electrical cable, which the piece of sheet metal holds at least in some areas. In order to achieve advantageous method conditions. the invention proposes that the piece of sheet metal be provided with the cable during its shaping or between two of its shaping steps and be attached to this cable in at least some areas in a nonpositive or integral fashion.

### FIELD OF THE INVENTION

The invention relates to a method for producing a structural component, in particular for a vehicle, in which a piece Of sheet metal is shaped into an open or closed, in particular multi-chambered, hollow profile and is provided with at least one electrical cable, which the piece of sheet metal holds at least in some areas.

### BACKGROUND OF THE INVENTION

In order to provide a structural component of a vehicle with a cable, it is known to pull it into the cavity of the completely profiled hollow profile. This approach disadvantageously requires an extended duration of the method and also a significant complexity of the production.

There are a wide variety of known shaping methods for producing a hollow profile from a piece of sheet metal. Among others, is a linear flow splitting, in which hollow profiles with multiple chambers are produced. Most often, at least one of these chambers is provided for holding the cable.

There are also methods known from the prior art for producing cables with a steel casing (DE3527714C2). In this case, two pieces of sheet metal are each roller profiled to form a U-shaped profile, a cable is inserted between the two finished U-shaped profiles, and then the two U-shaped profiles are welded together to form a steel casing. Inserting the cable before the welding of the U-shaped profiles can in fact make it easier to provide the piece of sheet metal with a cable, but because it involves a parallel shaping step with two pieces of sheet metal and the subsequent welding of them, the method is relatively complex—particularly with regard to matching up the abutting edges of the rolled profiles in order to enable a subsequent welding. Consequently, an increased method duration and a high production complexity can be expected here as well.

### SUMMARY OF THE INVENTION

The object of the invention, therefore, is to simplify—based on the above-explained prior art—a method for producing a hollow profile with an electrical cable provided in its cavity.

The invention attains the stated object in that the piece of sheet metal is provided with the cable during its shaping or between two of its shaping steps and is attached to this cable in at least some areas in a nonpositive or integral fashion.

If the piece of sheet metal is provided with the cable during its shaping or between two of its shaping steps and is attached to this cable in at least some areas in a nonpositive or integral fashion, then it is advantageously possible to eliminate a subsequent and usually complex pulling of a cable into the hollow profile. To be specific, the at most partially shaped piece of sheet metal can be shaped further into its final shape together with its adhering cable and thus also in a reliable fashion, which makes it possible to still ensure simple process conditions regarding; the manipulation of a cable, even with complex shaping. Moreover, with the further shaping of the piece of sheet metal, it is also unnecessary to carry out any matching to other profiled parts in order to thus produce a cavity for guiding the cable, allowing the method to reproducibly achieve even extremely complex closed or open hollow profiles. The cable, which is attached according to the invention to the piece of sheet metal to be shaped or shaped further, can thus contribute to significantly simplifying the operation of the method. In this way, it is possible to achieve the fact that an open or closed hollow profile with an electrical cable in its cavity can be produced efficiently and inexpensively.

In general, it should be noted that the nonpositive or integral attachment is essentially intended to prevent the cable from falling or slipping out of the hollow profile by itself as the hollow profile is being handled. For example, it is conceivable to achieve this effect of the nonpositive attachment in that the cable is snugly guided by the pre-profiled piece of sheet metal in order to thus ensure a sufficient static friction between the cable or cables and the piece of sheet metal. It should also be noted that an electric cable has at least one electric conductor that can be enclosed by an electrically insulating sleeve. In addition, the terms “electrical cable” and “electrical line” are used synonymously.

In general, it should be noted that the method according to the invention can be particularly advantageous when producing a hollow profile that is used as a structural component, for example, for a vehicle or aircraft. Structural components of this kind can be frame members, transverse control arms, or the like and in particular are used to enhance the mechanical rigidity of the vehicle or aircraft.

A sufficiently rigid connection between the piece of sheet metal and cable can be produced in an inexpensive way if at least one clamp is fastened to the piece of sheet metal, which attaches the cable to the piece of sheet metal in a nonpositive fashion.

Alternatively or also in addition to the clamp, a glue layer can be provided in at least some areas between the cable and the piece of sheet metal. Such a glue layer can also offer the advantage that complex shaping methods can be carried out on the piece of sheet metal without having to fear that the cable will detach from the piece of sheet metal. It is thus possible to virtually rule out the risk of damage to the cable, which can in turn ensure an increased reproducibility of the method.

A method that is easy to execute and control can be achieved if the piece of sheet metal is profiled into a hollow profile. This can be carried out by means of linear flow splitting and/or roller profiling. In particular, roller profiling can be advantageous in that it can provide for an inexpensively producible hollow profile with a cable held inside it.

A simplified operation when providing the piece of sheet metal with a cable can be achieved if in a shaping step, at least one guide recess extending along the longitudinal side of the piece of sheet metal is produced, which is provided with the cable. To be specific, the guide recess can be used both as an insertion aid and also for exactly aligning the cable. In particular, this exact positioning of the cable on the piece of sheet metal can avoid damage during the shaping, which damage can occur particularly during production of complex hollow profiles or complex hollow profile shapes. It is thus possible to enable a reliable and reproducible method.

Advantageously, the shaping of the piece of sheet metal can simultaneously also be used to attach the cable to the piece of sheet metal in a nonpositive fashion. This merely requires shaping the piece of sheet metal in a corresponding way, for example by having the piece of sheet metal rest snugly against the cable and thus producing an increased nonpositive engagement by means of which the cable is durably secured in the hollow profile in a way that prevents it from being pulled out in an unwanted fashion.

This nonpositive attachment between the cable and the piece of sheet metal can be enabled in that an undercut, which holds the cable with nonpositive engagement, is profiled into the piece of sheet metal. Such an undercut can, for example, be produced by bending over a partition wall on the piece of sheet metal. This can yield a simple method.

Alternatively or in addition to this, the nonpositive attachment can be developed or improved in its ruggedness if the piece of sheet metal is crimped together with the cable at different points.

If a carriage is guided along the piece of sheet metal, which shapes the piece of sheet metal in order to produce a nonpositive attachment to the cable, then the method sequence can be accelerated and its precision can he improved.

The method can be further simplified in that the carriage guides the cable to the piece of sheet metal and thus supplies it with the cable.

Tensile loads on the cable that can occur as it is being laid can thus be avoided by providing the piece of sheet metal with a cable that has a cable length greater than the length of the piece of sheet metal. It is thus possible to simplify cutting the hollow profile to length. The additional cable length in the hollow profile can allow for the possibility of cutting the hollow profile to length at any point along it—and permit a simple connection of the cable that is held in it.

If the cable is laid in a loop shape in at least some regions, then it is possible to provide a sufficient reserve length of the cable that is laid inside the hollow profile. In particular, a loop shape can he advantageous in the region in which the hollow profile and/or electrical branch line on the hollow profile is cut to length, for example to allow the cable to be taken out of the hollow profile.

The process of pulling the cable out can be facilitated in thin when the cable is laid in a loop shape, the nonpositive or integral attachment of the cable to the piece of sheet metal in this region is weakened in order to produce a predetermined break point. It is thus possible for even slight tensile forces on the cable to be sufficient to remove it from the hollow profile in order to connect it electrically. It is thus possible to significantly increase the ease of handling of a hollow profile.

A closed hollow profile can be produced in a simple way if the hollow profile is integrally joined at its longitudinal profile ends. Different welding methods can be used for this.

### BRIEF DESCRIPTION OF THE DRAWINGS

In the drawings, the subject of the invention is depicted by way of example by means of several exemplary embodiments of structural components. In the drawings:

FIG. 1 shows two method steps for producing a hollow profile with a cable in its cavity,

FIG. 2 shows a detail view of the method step according to FIG. 1 in which the piece of sheet metal is provided with a cable at the same time as the piece of sheet metal is being shaped into the hollow profile,

FIG. 3 shows a detail view of the method step in which the piece of sheet metal is crimped together with the cable in an alternative embodiment,

FIG. 4 shows a third embodiment of the method,

FIG. 5 shows a fourth embodiment of the method in which the cable is attached to the piece of sheet metal in a nonpositive fashion by means of clamps,

FIG. 6 shows a fifth embodiment of the method with an integral connection between the piece of sheet metal and the cable,

FIG. 7 shows a loop-shaped laying of the cable,

FIG. 8 shows a sixth embodiment of the method with a nonpositive attachment between the piece of sheet metal and the cable.

### DETAILED DESCRIPTION OF THE PREFERRED EMBODIMENTS

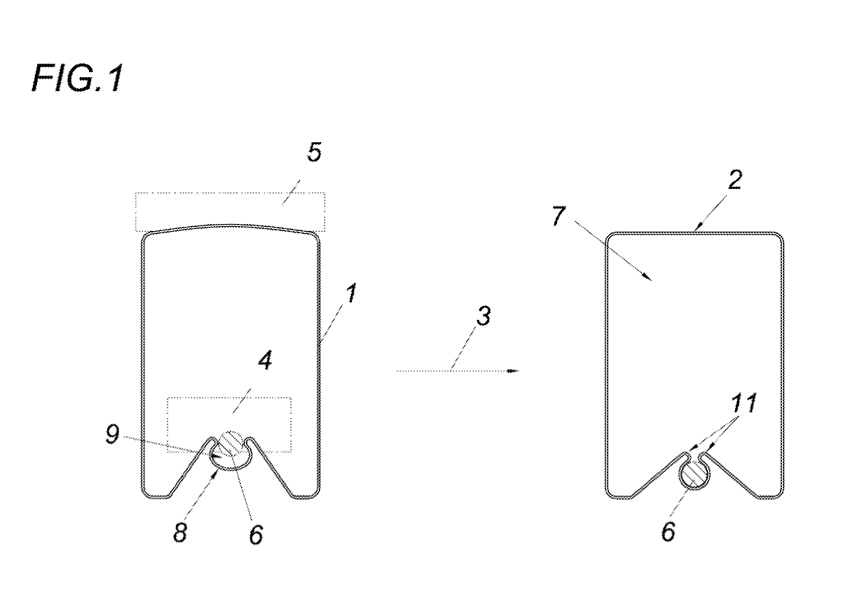

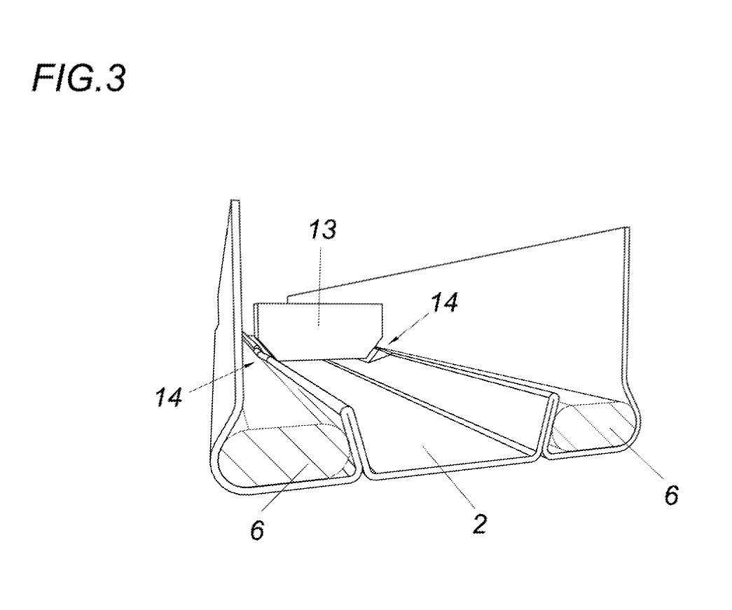

FIG. 1 shows an end view of an already partially shaped piece of sheet metal which is finally shaped into a hollow profile 2 with the aid of a roller profiling 3. In order to carry out this continuous bending process, rollers 4, 5 exert a load on the partially shaped piece of sheet metal 1 in order to bring it into the desired final cross-section in accordance with the hollow profile 2. The hollow profile 2 also has a cable 6, which extends in the cavity 7 of the hollow profile or is held by the hollow profile 2. In order to avoid a subsequent pulling of a cable 6 into the completed hollow profile 2, the piece of sheet metal 1 is already provided with the cable 6 before its final shaping—i.e. between two shaping steps, the partial shaping and the final shaping—as shown in FIG. 1. In a shaping step, a guide recess 8 has already been formed into the piece of sheet metal 1, extending along its longitudinal side in order to provide the cable 6 with a chamber 9 in the cavity 7 of the final profile 2. This chamber 9 can in particular also be advantageous for protecting the cable 6, particularly also in the further use of the hollow profile 2. The not yet finally shaped piece of sheet metal 1 can now be provided with the cable 6 in a comparatively simple fashion because its final dimensions according to the hollow profile 2 to be produced have not yet been achieved. In particular, however, the invention has the advantage that in the additional shaping 3—or in this case, the final shaping—of the piece of sheet metal 1, the cable 6 is attached to the piece of sheet metal 1 in a nonpositive fashion in at least some areas, which is particularly visible in FIG. 3. It is thus possible to achieve a structural component that can be inexpensively produced.

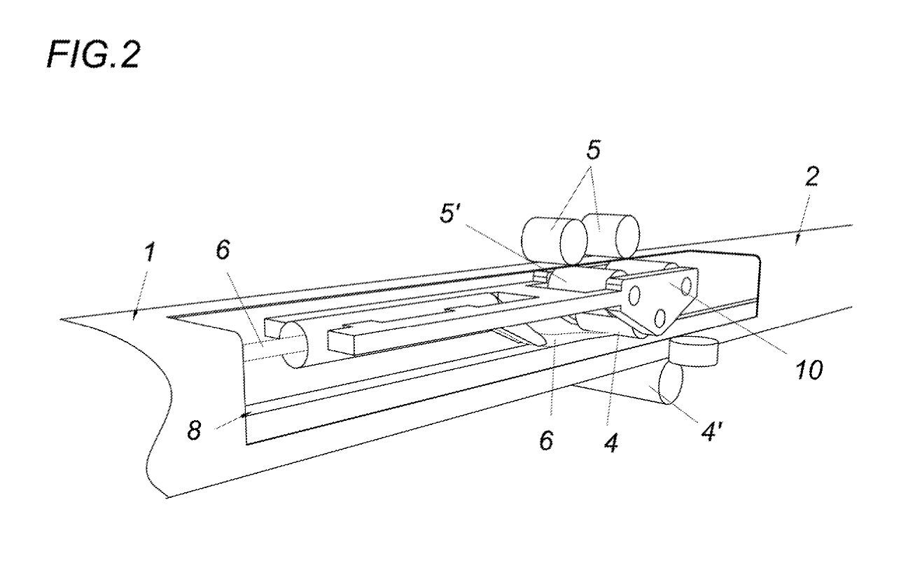

FIG. 2 shows a carriage 10, which is pulled through the partially shaped piece of sheet metal 1, is guided along the piece of sheet metal 1, inserts the cable 6 into the guide recess 8, and subjects the guide recess 8 to further roller profiling by means of its associated rollers 4 and 4′. This shaping closes the guide recess 8 and thus produces an undercut that holds the cable 6 in a nonpositive fashion, which undercut 11 is visible, for example, in the drawing on the right in FIG. 1. In addition, this shaping also gives the outer region and inner region of the piece of sheet metal the desired final shape, as is clear from a comparison between the piece of sheet metal 1 and the closed hollow profile 2 according to FIG. 1. For this purpose, the carriage 10 is associated with several additional rollers 5, 5′.

In addition or alternative to the carriage 10 according to FIG. 2, FIG. 3 shows that the piece of sheet metal can also be shaped with a crimping tool 13. With the aid of the crimping tool 13, the piece of sheet metal 1 is crimped together with the cable 6, as is visible at the crimping points 14. These crimping points 14 are sufficient to provide a nonpositive attachment between the piece of sheet metal 1 and the cable 6. It is thus possible to produce a durable structural component.

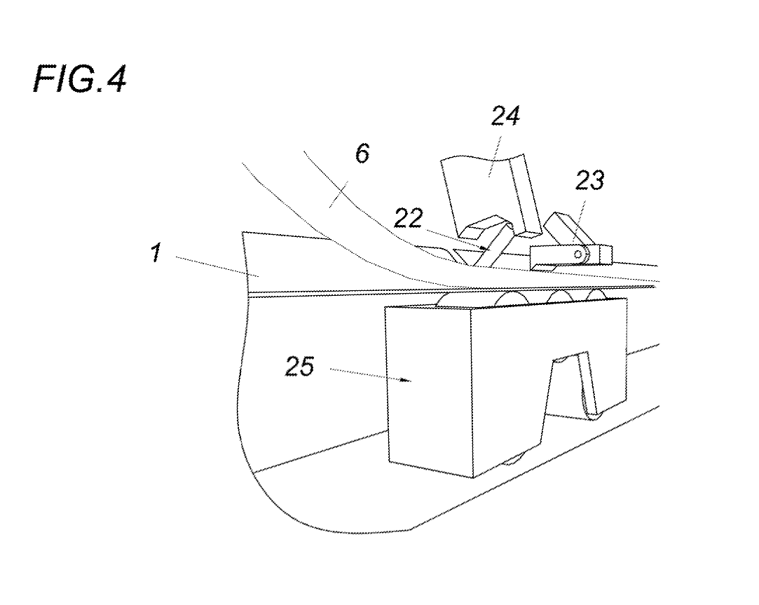

FIG. 4 shows a nonpositive attachment in which a strip 22 is punched out from the piece of sheet metal 1 with the aid of a cutting tool 23. This strip 22 is bent over the cable 6 with the aid of a shaping tool 24 situated after the cutting tool 23 and in cooperation with a carriage 25.

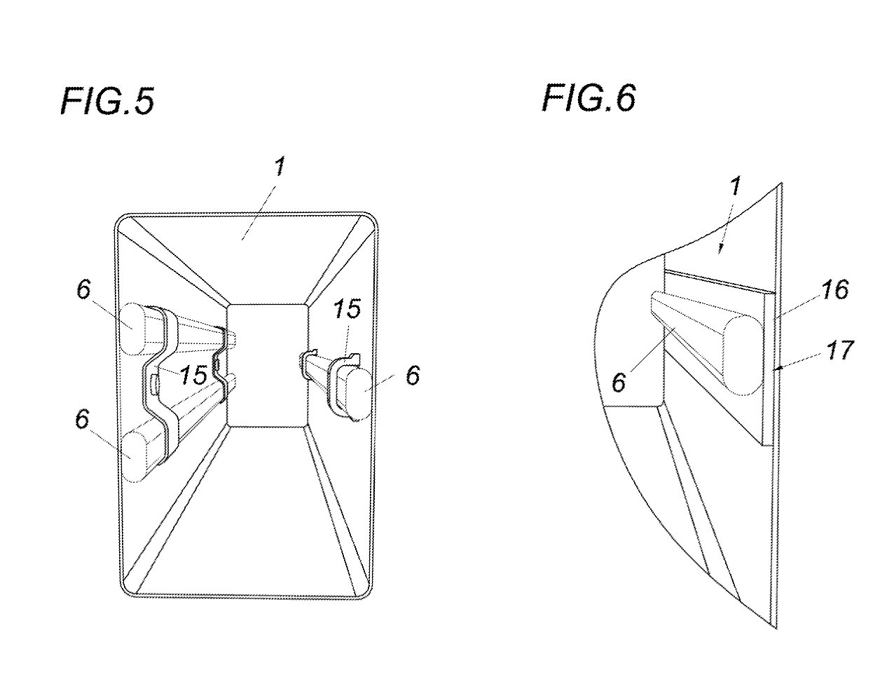

FIG. 5 shows a nonpositive attachment of the cable 6 to the piece of sheet metal 1 by means of clamps. The clamps 15 are riveted to the piece of sheet metal 1, inserted into it, or attached to the piece of sheet metal 1 in some other way.

It is also conceivable for there to be an integral connection between the piece of sheet metal 1 and the cable 6 in order to affix the cable to the piece of sheet metal 1, which is shown in greater detail in FIG. 6. The piece of sheet metal 1 has a double-sided adhesive strip 16 mounted onto it, which constitutes a glue layer 17 and thus fastens the cable 6 to the piece of sheet metal 1.

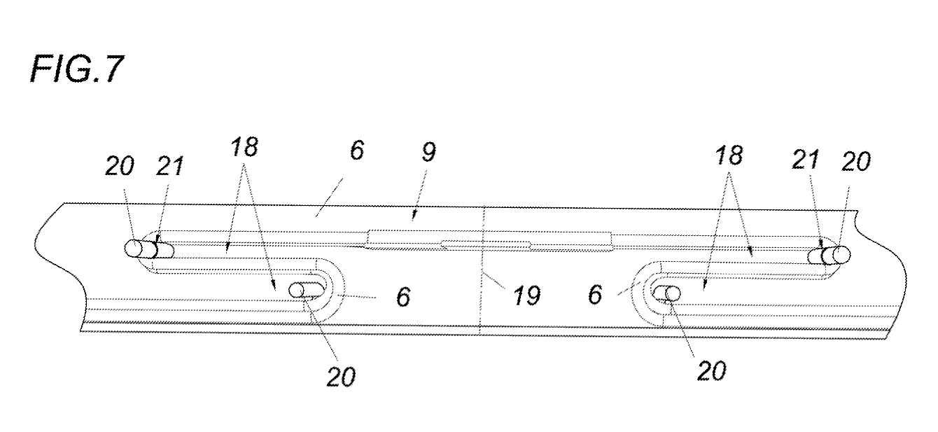

FIG. 7 shows how the piece of sheet metal 1 can be provided with a cable 6, which has a cable length that is greater than the length of the piece of sheet metal 1.

For this purpose, the cable 6 is laid in a loop shape so as to form cable loops 18 in the cavity 7 of the hollow profile 2. Particularly in the region of an edge of the cut 19, this makes it possible for the cable 6, which is connected to the piece of sheet metal 1 in a nonpositive and/or integral fashion, to be pulled out from the hollow profile 2 far enough to connect it electrically. Specifically with structural components that are cut to length as needed, this constitutes a significant simplification of the process.

The cable loops 18 are held in the hollow profile 2 by means of pins 20, where the outer pins 20 have a predetermined break point 21. It is thus possible to assure a weakening of the nonpositive or integral attachment of the cable 6 to the piece of sheet metal 1 in order to make it easier to pull out the cable 6.

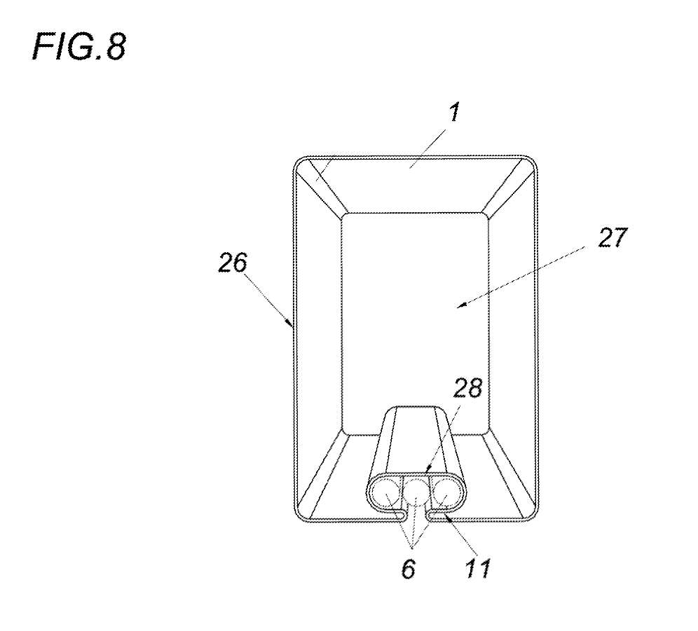

FIG. 8 shows an open, hollow profile 26 with a plurality of chambers 27, 28. This hollow profile 26 holds three cables 6 in its chamber 28. An undercut 11 is formed into the piece of sheet metal 1 in order to attach of the cables 6 to the piece of sheet metal 1 in a nonpositive fashion.

1. A method for producing a structural component, in particular for a vehicle, comprising:
shaping a piece of sheet metal into an open or closed, mufti-chambered, hollow profile and providing the piece of sheet metal with at least one electrical cable during its shaping or between two of its shaping steps, which the piece of sheet metal holds at least in some areas and is attached to this cable in at least some areas in a nonpositive or integral fashion.

2. The method according to claim 1, further comprising fastening at least one clamp to the piece of sheet metal, thereby attaching the cable to the piece of sheet metal in a nonpositive fashion.

3. The method according to claim 1, further comprising providing a glue layer in at least some areas between the cable and the piece of sheet metal.

4. The method according to claim 1, comprising profiling the piece of sheet metal into a hollow profile by linear flow splitting and/or roller profiling.

5. The method according to claim 1, comprising, in a shaping step, producing at least one guide recess extending along a longitudinal side of the piece of sheet metal, which is provided with the cable.

6. The method according to claim 1, comprising shaping the piece of sheet metal in relation to the cable so as to form a nonpositive attachment between the cable and the piece of sheet metal.

7. The method according to claim 6, comprising profiling an undercut into the piece of sheet metal, wherein the undercut holds the cable in a nonpositive fashion.

8. The method according to claim 6, comprising crimping the piece of sheet metal together with the cable at different points.

9. The method according to claim 6, comprising guiding a carriage along the piece of sheet metal and to shape the piece of sheet metal to produce the integral connection with the cable.

10. The method according to claim 9, wherein the carriage guides and thus supplies the cable to the piece of sheet metal.

11. The method according to claim 1, wherein the piece of sheet metal is provided with a cable, which has a cable length that is greater than the length of the piece of sheet metal.

12. The method according to claim 11, wherein the cable is laid in a loop shape, at least in a region of a cut of the hollow profile and/or electrical branch line on the hollow profile.

13. The method according to claim 12, wherein with the loop-shaped laying of the cable, the nonpositive or integral attachment of the cable to the piece of sheet metal is weakened in this region in order to produce a predetermined break point.

14. The method according to claim 12, wherein with the loop-shaped laying of the cable, these cable regions are at least partially affixed to each other in a detachable fashion.

15. The method according to claim 1, wherein the hollow profile is integrally joined at its longitudinal profile ends in order to produce a closed hollow profile.
